(19) United States
(12) Patent Application Publication
(10) Pub. No.: US 2010/0309362 A1
(43) Pub. Date: Dec. 9, 2010

(54) LENS APPARATUS AND CONTROL METHOD FOR THE SAME

(75) Inventor: Toru Nagata, Tokyo (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/780,164

(22) Filed: May 14, 2010

(30) Foreign Application Priority Data
Jun. 3, 2009 (JP) 2009-134299

(51) Int. Cl. H04N 5/225

(52) U.S. Cl. 348/335; 348/E05.028

(57) ABSTRACT

A lens control unit transmits the pattern of openings and non-openings of an aperture plate as a pattern image to a digital single-lens reflex camera when an aperture plate driving mechanism places the aperture plate at a specified position on an optical path in accordance with an external instruction.

### BACKGROUND OF THE INVENTION

1. Field of the Invention

The present invention relates to a lens apparatus, which is detachable with respect to a lens-interchangeable image capturing device, and a control method for the same.

2. Description of the Related Art

Patent reference 1 (U.S. Pat. No. 6,278,847) and patent reference 2 (Japanese Patent Laid-Open No. 07-270674) disclose techniques which acquire three-dimensional information of an object by using, for example, an aperture having a plurality of openings rather than an aperture having a single circular or polygonal opening shape, and are used for autofocus. According to these techniques, lenses are fixed to cameras, and only aperture shapes prepared upon design are used. This is also the case when aperture shapes are switched in use. That is, since a CPU for camera control issues an instruction to switch aperture shapes, this arrangement is equivalent to aperture shapes prepared upon design.

There is conventionally used a method of changing soft focus effects by using the spherical aberration of a soft focus lens. This method uses a modified aperture to control the amount of light beam passing through the peripheral portion the aperture, where a large amount of spherical aberration occurs. A practical example of this method is introduced in, for example, non-patent reference 1 (“SHASHIN KOGYO” monthly magazine, 2004 April issue, p. 46).

When a lens-interchangeable camera uses a lens having a modified aperture like a coded aperture, aperture opening shape information is essential to image processing for captured images. It is therefore essentially necessary to transfer aperture opening shape information from the lens to the camera.

In this case, it is necessary to optimize an aperture opening shape in accordance with the information desired to be acquired by image capturing, the purpose of image processing, and the optical design of a lens provided with a modified aperture. That is, since an aperture opening shape changes in accordance with the function to be implemented, or if the lens for implementing the function differs in design, the functional requirements and design of the lens in accordance with, it is impossible to determine aperture opening shape information in advance based on future prospects. At this time, in order to maintain the inter-generation compatibility between cameras and lenses (and image processing units), it is necessary to allow to define aperture shapes regardless of design generation and to transfer the corresponding information.

### SUMMARY OF THE INVENTION

The present invention has been made in consideration of the above problem, and provides a versatile aperture shape information transfer technique.

According to the first aspect of the present invention, a lens apparatus configured to be detachable with respect to a lens-interchangeable image capturing device, and the lens apparatus includes an aperture plate having a plurality of openings, and includes a control mechanism which places the aperture plate at a specified position on an optical path and retracts the aperture plate from the specified position in accordance with external instructions, comprising: a unit which holds a pattern of openings and non-openings of the aperture plate as a pattern image; and a transmission unit which transmits the pattern image to the lens-interchangeable image capturing device when the control mechanism places the aperture plate at the specified position on the optical path in accordance with the external instruction.

According to the second aspect of the present invention, a control method for a lens apparatus configured to be detachable with respect to a lens-interchangeable image capturing device, and the lens apparatus includes an aperture plate having a plurality of openings, and includes a control mechanism which places the aperture plate at a specified position on an optical path and retracts the aperture plate from the specified position in accordance with external instructions, comprising: transmitting a pattern of openings and non-openings of the aperture plate as a pattern image to the lens-interchangeable image capturing device when the control mechanism places the aperture plate at the specified position on the optical path in accordance with the external instruction.

Further features of the present invention will become apparent from the following description of exemplary embodiments with reference to the attached drawings.

### BRIEF DESCRIPTION OF THE DRAWINGS

FIG. 1 is a block diagram showing an example of the arrangement of a camera system constituted by a digital single-lens reflex camera as a lens-interchangeable image capturing device, and a lens apparatus according to an embodiment;

FIG. 2 is a view showing the opening shape of an aperture 204;

FIG. 3 is a view showing the opening shape of an aperture plate 208;

FIGS. 4A and 4B are views showing an example of the configuration of lens information which a lens control unit 206 transmits to a camera control unit 111 upon receiving information indicating the use of the aperture plate 208 from the camera control unit 111;

FIG. 5 is a view showing an example of the configuration of a captured image file;

FIG. 6 is a view showing graphs 691 to 693;

FIG. 7 is a view showing graphs 691, 792, and 793;

FIG. 8 is a flowchart of processing for obtaining a distance image using a captured image file;

FIG. 9A is a perspective view showing an image to be processed in accordance with the flowchart of FIG. 8;

FIG. 9B is a view showing a processed image (distance image);

FIGS. 10A and 10B are views for explaining the principle of a soft focus lens using spherical aberration; and

FIGS. 11A and 11B are views showing two types of aperture plates having different control effects.

### DESCRIPTION OF THE EMBODIMENTS

An embodiment of the present invention will be described below with reference to the accompanying drawings. Note that the embodiment described below is a specific example in which the present invention is executed, and is one of specific embodiments of the arrangement defined in the claims.

This embodiment will exemplify a lens apparatus which is configured to be detachable with respect to a lens-interchangeable image capturing device, and includes an aperture plate having a plurality of openings and a control mechanism for placing the aperture plate at a specified position on an optical path or retract the aperture plate from the specified position in accordance with an external instruction. For the sake of descriptive convenience, the embodiment uses a digital single-lens reflex camera as a lens-interchangeable image capturing device. However, an image capturing device which can be used as a lens-interchangeable image capturing device is not limited to this, and an image capturing device such as a compact digital camera or digital video camera may be used.

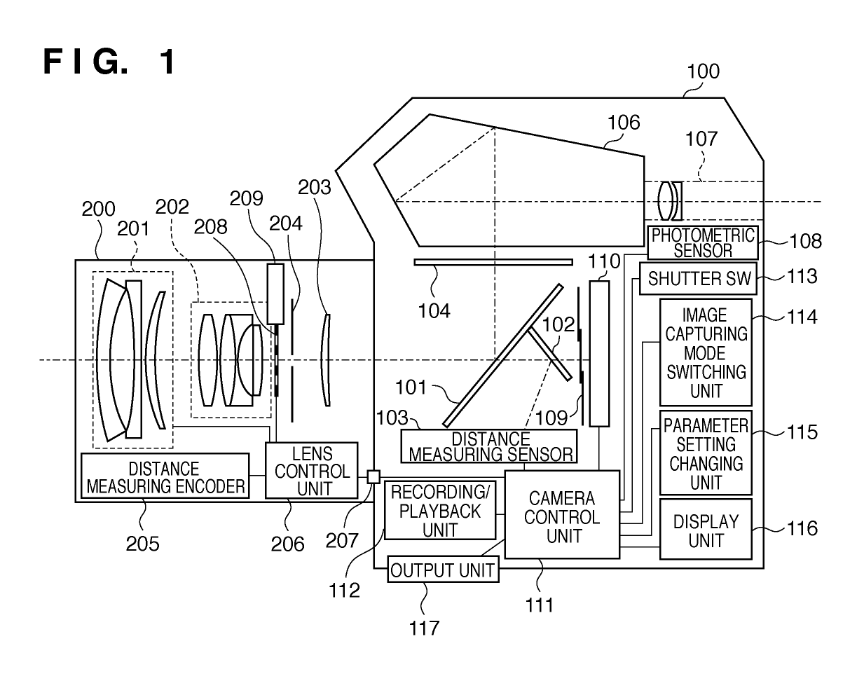

FIG. 1 is a block diagram showing an example of the arrangement of a camera system comprising a digital single-lens reflex camera as a lens-interchangeable image capturing device and a lens apparatus according to this embodiment. Referring to FIG. 1, reference numeral 100 denotes a digital single-lens reflex camera; and 200, a lens apparatus. FIG. 1 shows a camera system in which the lens apparatus 200 is attached to the digital single-lens reflex camera 100.

The lens apparatus 200 will be described first. In the lens apparatus 200, reference numerals 201 to 203 denote lens elements. The lens element 201 is a focusing lens group which moves back and forth on an optical axis to adjust a focus position on a captured frame. The lens element 202 is a variable-power lens group which moves back and forth on an optical axis to change the focal length of the lens apparatus 200 and change the magnification of a captured frame. The lens element 203 is a fixed lens for improving lens performance such as telecentricity.

Reference numeral 204 denotes an aperture; and 205, a distance measuring encoder which reads the position of the focusing lens group 201 and generates a signal corresponding to the position information of the focusing lens group 201, in other words, an object distance. The distance measuring encoder 205 transmits the generated signal to a lens control unit 206 on the subsequent stage.

The lens control unit 206 changes the opening diameter of the aperture 204 based on a signal transmitted from the digital single-lens reflex camera 100, and controls the movement of the focusing lens group 201 based on a signal transmitted from the distance measuring encoder 205. The lens control unit 206 transmits, lens information including an object distance corresponding to a signal transmitted from the distance measuring encoder 205, a focal length based on the position information of the variable-power lens group 202, and an F-number based on the opening diameter of the aperture 204, to the digital single-lens reflex camera 100.

Reference numeral 207 denotes a mount contact group serving as a communication interface between the lens apparatus 200 and the digital single-lens reflex camera 100; 208, an aperture plate which is retractably provided on an optical path and has a plurality of openings; and 209, an aperture plate driving mechanism serving as a control mechanism for placing the aperture plate 208 at a specified position on an optical path or retract the aperture plate 208 from the specified position in accordance with an external instruction. The lens control unit 206 drives the aperture plate driving mechanism 209, and hence can determine whether the currently used aperture is the aperture 204 or the aperture plate 208. The lens control unit 206 transmits a pattern of openings and non-openings of the aperture plate 208 as a pattern image (aperture shape information) to a camera control unit 111 only when the aperture plate 208 is currently used (the aperture plate 208 is placed at the specified position). Note that this pattern image is generated in advance and stored in a memory (not shown) (for example, a memory (not shown) in the lens control unit 206) in the lens apparatus 200.

The digital single-lens reflex camera 100 will be described next. Reference numeral 101 denotes a main mirror, which is obliquely placed in an image capturing optical path in a viewfinder observation state, and is retracted outside the image capturing optical path in an image capturing state. The main mirror 101 is a half mirror, which transmits almost half of a light beam from an object to make the light strike a distance measuring sensor 103 (to be described later) when it is obliquely inserted in the image capturing optical path. Reference numeral 104 denotes a viewfinder screen placed on a prospective imaging plane of the lens elements 201 to 203. An operator checks a captured frame by observing the viewfinder screen 104 through an eyepiece 107. In this case, reference numeral 106 denotes a pentaprism, which changes an optical path to guide a light beam from the viewfinder screen 104 to the eyepiece 107.

The distance measuring sensor 103 receives a light beam from the lens apparatus 200 through the sub-mirror 102 retractably placed on the rear side of the main mirror 101. The distance measuring sensor 103 sends the state of the received light beam to the camera control unit 111. The camera control unit 111 determines the focus state of the lens apparatus 200 with respect to an object based on the received state. The camera control unit 111 then calculates the operating direction and operation amount of the focusing lens group 201 based on the determined focus state and the position information of the focusing lens group 201 which is sent from the lens control unit 206.

Reference numeral 108 denotes a photometric sensor which measures the luminance in a predetermined area on a frame displayed on the viewfinder screen 104, generates a signal (luminance signal) indicating the measured luminance, and transmits the generated luminance signal to the camera control unit 111. The camera control unit 111 determines a proper amount of exposure for an imaging sensor 110 based on the luminance signal transmitted from the photometric sensor 108. The camera control unit 111 also controls the aperture 204 in accordance with the image capturing mode selected by an image capturing mode switching unit 114 and the shutter speed set to obtain the above proper amount of exposure. In addition, the camera control unit 111 controls the shutter speed of a shutter 109 in accordance with the information of the aperture plate 208, which is transmitted together with a set aperture value or lens information. In some cases, the camera control unit 111 performs a combination of the above control operations.

Assume that the user has selected “shutter speed priority mode” by operating the image capturing mode switching unit 114. In this case, the camera control unit 111 calculates the opening diameter of the aperture 204 with which the above proper amount of exposure is obtained for the shutter speed set by a parameter setting changing unit 115. The camera control unit 111 transmits a control signal to the lens control unit 206 so as to make the opening diameter of the aperture 204 become the calculated opening diameter. With this operation, the lens control unit 206 controls the aperture 204 based on the control signal from the camera control unit 111 so as to make the opening diameter of the aperture 204 become the opening diameter calculated by the camera control unit 111.

Assume that the user has selected “aperture priority mode” or “aperture plate using image capturing mode” by operating the image capturing mode switching unit 114. In this case, the camera control unit 111 calculates a shutter speed with which a proper amount of exposure is obtained in accordance with a set aperture value or the selection/non-selection of the aperture plate 208. If the selection of the aperture plate 208 is designated, the lens control unit 206 transmits the above pattern image and parameters associated with exposure to the digital single-lens reflex camera 100.

Assume that the user has selected “program mode” by operating the image capturing mode switching unit 114. In this case, the camera control unit 111 determines a shutter speed and an aperture value in accordance with a combination of the shutter speed and aperture value or the use of the aperture plate determined for the above proper amount of exposure.

The processing in either of the above modes is started at the timing when the camera control unit 111 detects that the user has pressed a shutter SW 113 to its half stroke. At this time, the lens control unit 206 drives the focusing lens group 201 until the position information indicated by the distance measuring encoder 205 coincides with a target operation amount in accordance with the operating direction and operation amount of the focusing lens group 201 which are determined by the camera control unit 111.

When the camera control unit 111 detects that the user has fully pressed the shutter SW 113, an image capturing sequence starts. When the image capturing sequence starts, the main mirror 101 and the sub-mirror 102 are folded and retracted from the image capturing optical path. The camera control unit 111 then transmits the calculated aperture value to the lens control unit 206. The lens control unit 206 stops down the aperture 204 based on this aperture value. In addition, when the mode using the aperture plate 208 is to be set, the camera control unit 111 transmits corresponding information to the lens control unit 206. In this case, the lens control unit 206 controls the aperture plate driving mechanism 209, and places the aperture plate 208 in the optical path. Subsequently, the shutter 109 opens or closes in accordance with the shutter speed calculated by the camera control unit 111. Thereafter, the aperture 204 opens or the aperture plate 208 retracts. The main mirror 101 and the sub-mirror 102 return to the original positions.

The imaging sensor 110 transfers an electric charge value corresponding to each pixel, which is stored while the shutter 109 is open, as a luminance signal, to the camera control unit 111. With this operation, the camera control unit 111 maps the luminance signals in a proper color space to create a file (captured image file) in a proper format. Reference numeral 116 denotes a display unit provided on the rear surface of the digital single-lens reflex camera 100. The display unit displays an operation window to operate the image capturing mode switching unit 114 and the parameter setting changing unit 115, or thumbnail images generated by the camera control unit 111 after image capturing. The display unit 116 also displays the pattern image transmitted from the lens control unit 206.

Reference numeral 112 denotes a recording/playback unit which reads/writes data from/in a recording medium such as a memory card which is detachable with respect to the digital single-lens reflex camera 100. That is, the recording/playback unit 112 records the file created by the camera control unit 111 after image capturing on a recording medium such as a memory card, and reads out a file recorded on the recording medium. Reference numeral 117 denotes an output unit which outputs the file created by the camera control unit 111 after image capturing to an external computer or the like via a cable or the like.

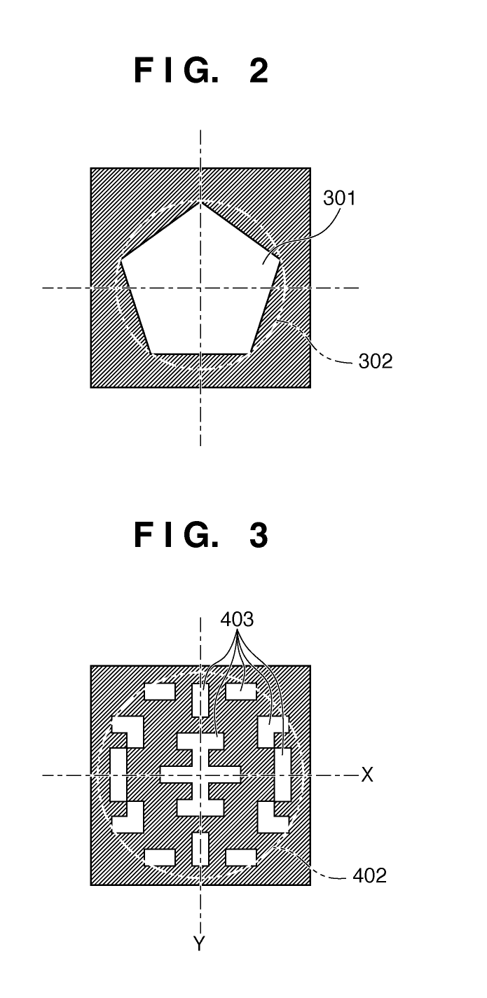

The aperture 204 and the aperture plate 208 will be described next. FIG. 2 is a view showing the opening shape of the aperture 204. In this embodiment, since an iris diaphragm comprising five aperture blades is used as the aperture 204, the opening shape is a rounded pentagonal shape. Referring to FIG. 2, reference numeral 301 denotes an aperture shape when the aperture is open; and 302, a circle which provides an open aperture when it is open in a circular shape.

FIG. 3 is a view showing the opening shape of the aperture plate 208. As described above, the aperture plate 208 comprises many openings and other portions (non-openings). Referring to FIG. 3, reference numeral 402 denotes an open aperture like reference numeral 302 in FIG. 2; and 403, the openings of the modified aperture which are symmetrical about an optical axis perpendicular to the drawing surface. Therefore, reference numeral 403 indicates only the openings in the first quadrant of an orthogonal coordinate system with two orthogonal axes (X, Y) defined within a plane of the aperture plate 208 with the optical axis being the origin in FIG. 3.

The above pattern image can therefore be expressed as, for example, a binary image obtained by expressing each opening as “1” and each non-opening as “0” (in other words, a binary image obtained by assigning different bit values to each opening and each non-opening). In this case, it is necessary to provide information (size) indicating how much area one pixel in this pattern image indicates on the actual aperture plate 208. The lens control unit 206 therefore transmits this size information in addition to the pattern image.

As shown in FIG. 3, the aperture plate 208 transmits only part of a light beam passing through the open aperture, and hence decreases the amount of light transmitted through the lens. The value of an F-number representing an aperture ratio that provides the same amount of transmitted light as that after this decrease will be referred as a T-number. That is, a T-number is an index representing the true speed of the lens, which cannot be expressed by an aperture ratio (F-number) alone. Upon receiving information indicating the use of the aperture plate 208 from the camera control unit 111, the lens control unit 206 transmits this T-number information as the speed information of the lens to the camera control unit 111.

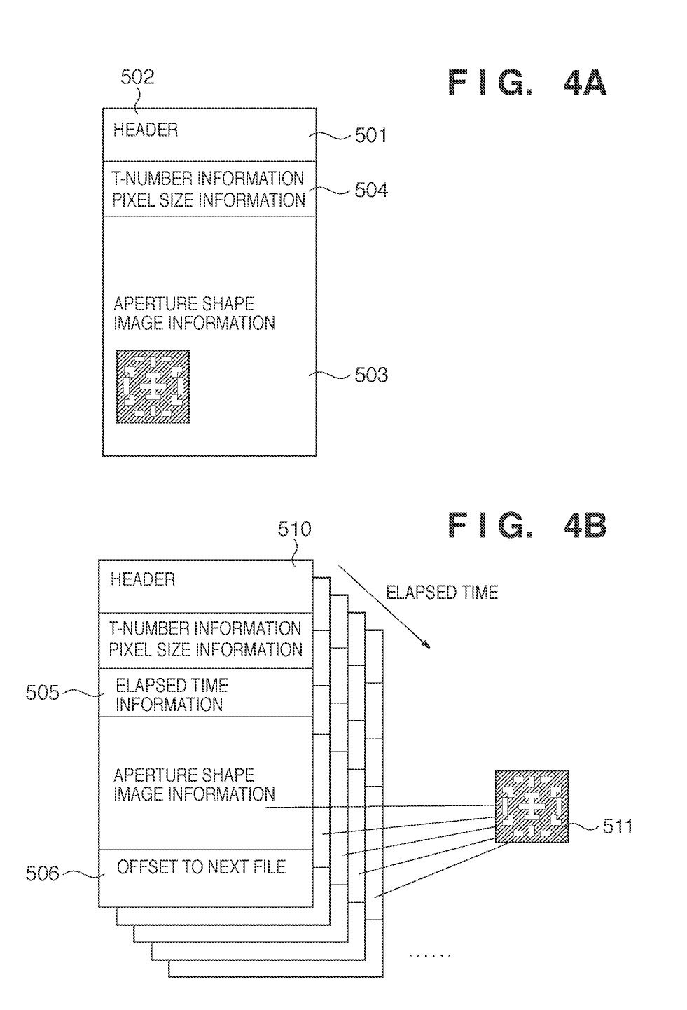

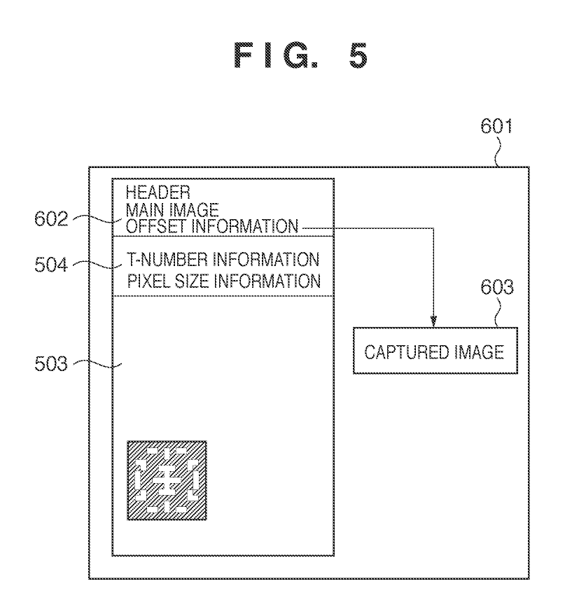

FIGS. 4A and 4B are views showing an example of the configuration of lens information which the lens control unit 206 transmits to the camera control unit 111 upon receiving information indicating the use of the aperture plate 208 from the camera control unit 111. FIG. 4A shows an example of the configuration of lens information to be transmitted when one still image is to be captured. FIG. 4B shows an example of the configuration of lens information to be transmitted when a moving image is to be captured.

Referring to FIG. 4A, reference numeral 501 denotes an aperture shape file as lens information; 502, a header portion; 504, a metadata portion which holds the above T-number information, the above size information, and the like; and 503, an image information portion which holds a pattern image. In this case, a pattern image is, for example, a binary image with a size of 13×13 pixels obtained by expressing each opening as “1” and each non-opening as “0”. The file format of the aperture shape file 501 may be a tag format or a box format. In addition, a pattern image is not limited to a binary image, and may be a multilevel image formed by assigning a pixel value corresponding to the transmittance of light to each pixel on a pattern image which corresponds to an opening. Furthermore, a pattern image can be formed by means of a vector image, such as SVG, to express the aperture shape.

Referring to FIG. 4B, reference numeral 510 denotes an aperture shape file corresponding to one frame. That is, the aperture shape file 501 shown in FIG. 4A is basically created for each frame. The aperture shape file 510 includes the following elements in addition to the aperture shape file 501. Reference numeral 505 denotes a holding portion which holds elapsed time information indicating the elapsed time from the start time of moving image capturing; and 506, a holding portion which holds file offset information indicating differences in byte-coordinate indicating a shift from one file to the next file.

When the lens control unit 206 transmits lens information having such a configuration to the camera control unit 111, the camera control unit 111 controls the recording/playback unit 112 to record this lens information as one file (captured image file) on a recording medium, together with a captured image. Obviously, if the captured image is linked with the lens information, it is possible to record them as different files on the recording medium. For the sake of simplicity, this embodiment will exemplify a case in which lens information and a captured image are recorded together on a captured image file.

An example of the use of a captured image file recorded on a recording medium in this manner will be described next. Inserting such a recording medium into a computer such as a PC (Personal Computer) or connecting the digital single-lens reflex camera 100 to the computer allows the computer to acquire a captured image file from the recording medium. Obviously, there are various forms in which the computer acquires captured image files. Extracting lens information from this acquired captured image file allows the computer to use the extracted lens information for image processing for images in the captured image file and display a pattern image in the lens information.

FIG. 5 is a view showing an example of the configuration of a captured image file. Reference numeral 601 denotes a captured image file; 602, a header in which main image offset information indicating the byte position of a captured image 603 in the captured image file 601 is written; and 603, a captured image. As file formats, the following are conceivable: the general TIFF format, the TIFF/EP format defined in ISO12234-2, the Exif format (compressed/uncompressed) based on the CIPA (Camera and Imaging Products Association)/JEITA (Japan Electronics and Information Technology Industries Association) standard, the JFIF format for general JPEG file format, and the JPEG2000 file format. That is, it is possible to use a proper file format in accordance with a purpose.

A method of acquiring a distance image by using the pattern image shown in FIG. 3 will be described below as an example of the actual use of a pattern image. There are many small openings in the image capturing optical system including the aperture plate 208 having a pattern of openings and non-openings indicated by the pattern image shown in FIG. 3. For this reason, the power spectrum obtained by Fourier transformation of the PSF (Point Spread Function) has “0” at several spatial frequencies. It is also known that the value of the spatial frequency that gives “0” changes in accordance with the object distance. This point is described in the following reference:

Levin et al., “Image and Depth from a Conventional Camera with a Coded Aperture”, ACM Transactions on Graphics, Vol. 26, No. 3, Article 70, Publication date: July 2007

Using this phenomenon can provide a distance image of an object.

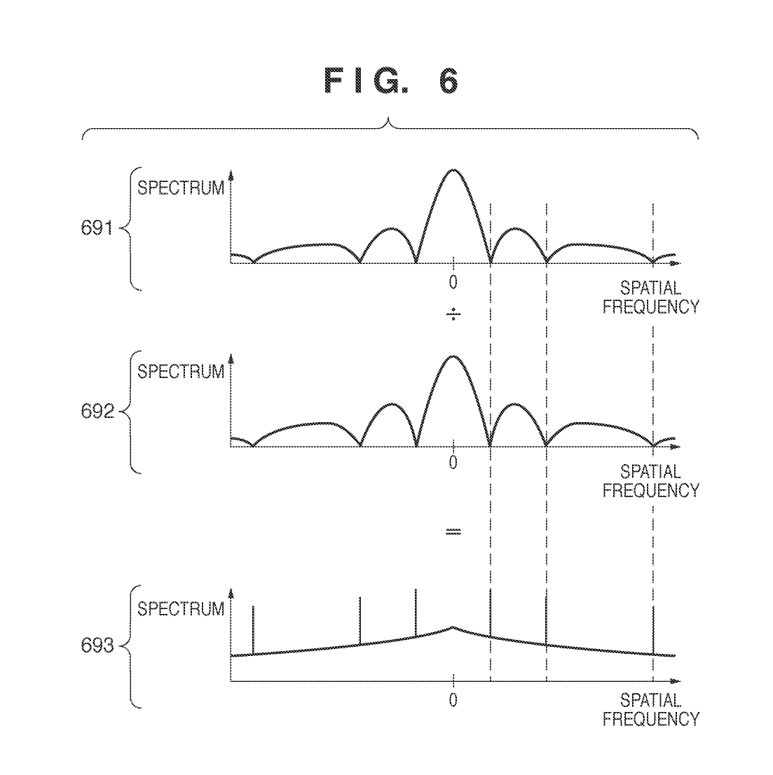

FIG. 6 is a view showing graphs 691 to 693. The graph 691 shows the power spectrum of a captured image at a given image capturing distance. The graph 692 shows the power spectrum obtained from the PSF of the image capturing optical system based on the object at the same image capturing distance. The graph 693 shows the result obtained by dividing the power spectrum in the graph 691 by the power spectrum in the graph 692. In each graph, the abscissa represents spatial frequencies; and the ordinate, the values of the power spectrum.

The power spectra shown in the graphs 691 and 692 are generated by the same aperture opening shape, and hence become 0 at the same spatial frequencies. For this reason, in the power spectrum shown in the graph 693, a spike appears at the “0” spatial frequency point. However, the width of the spike is very small.

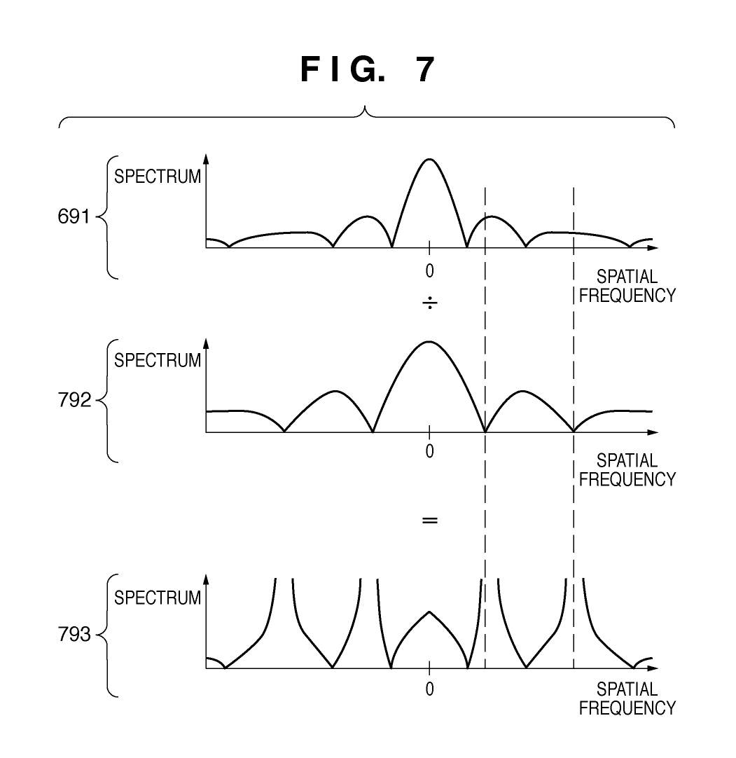

FIG. 7 is a view showing graphs 691, 792, and 793. The graph 792 shows the power spectrum obtained from the PSF of the image capturing optical system at an image capturing distance different from that for the graph 691. Since the spatial frequency of the PSF of the image capturing optical system which gives “0” changes depending on the object distance, the spatial frequencies of the two power spectra which give “0” do not coincide with each other. For this reason, as indicated by the graph 793, the result (power spectrum) obtained by dividing the power spectrum of the graph 691 by the power spectrum of the graph 792 includes a peak having a large width centered on the “0” spatial frequency point of the optical system power spectrum.

A comparison between FIGS. 6 and 7 reveals the following. Image capturing is performed by using the aperture plate having the opening/non-opening pattern shown in FIG. 3. The power spectrum of a given portion in the captured image is divided by the power spectrum (known) of the optical system which corresponds to a specific object distance. The power spectrum obtained as the quotient includes a large peak with a width when the two power spectra are obtained at different distances, and includes no peak with a width when the two power spectra are obtained at the same distance. Therefore, optical system power spectra corresponding to the number of object distance areas to be segmented are prepared in advance, and the power spectra of the respective portions of a captured image are divided by this number. An object distance area corresponding to a quotient exhibiting only a peak with a predetermined width or less indicates the object distance of the corresponding portion of the captured image.

With the above processing, it is possible to obtain a distance image by segmenting a captured image into areas according to the object distances of the respective portions of the image. The camera control unit 111 or the above computer may perform this processing.

FIG. 8 is a flowchart of processing for obtaining a distance image by using a captured image file. As described above, the camera control unit 111 or the CPU which the computer has may mainly perform this processing. When the CPU is to mainly perform this processing, it is necessary to acquire information necessary for the processing from the digital single-lens reflex camera 100.

First of all, in step S801, the camera control unit or CPU obtains the distance information of the lens (image capturing distance information) from the position information of the focusing lens group 201 after the end of focusing. In step S802, the camera control unit or CPU calculates the PSFs of the image capturing optical system and their power spectra when an object distance area is divided into p stages based on the acquired distance information. The camera control unit or CPU may calculate them from aperture shape information and lens information or by using an image capturing optical system PSF and its power spectrum stored in advance as database information in combination with aperture shape information.

In step S803, the camera control unit or CPU extracts a specific small area of the captured image, for example, an area of a size (m pixels×m pixels) that covers the maximum blur amount in a distance area to be created. In step S804, the extracted small area is Fourier-transformed to obtain a power spectrum. In step S805, the camera control unit or CPU initializes a distance area index n to 1 to start comparison with this power spectrum from the first distance area.

In step S806, the camera control unit or CPU divides the power spectrum of the obtained small area of the image by the optical system power spectrum of a distance area n. In step S807, the camera control unit or CPU compares a predetermined value WO with the width of the portion which gives a power spectrum value PO exceeding 1 to determine whether the width is smaller than the predetermined value WO. Upon determining that the width is smaller than the predetermined value, the camera control unit or CPU determines that the object distance of the small image area corresponds to the distance area at this time. The process then advances to step S808.

In step S808, the camera control unit or CPU assigns the distance index n to the area. If the camera control unit or CPU determines in step S807 that the width is not smaller than the predetermined value WO, since the object distance of the small image area does not coincide with the distance area at this time, the process advances to step S809. In step S809, the camera control unit or CPU compares the index value n with P to determine whether processing for all the object distance areas is complete (whether n=p). If the camera control unit or CPU determines that n=p, the process advances to step S814. In step S814, the camera control unit or CPU determines that there is no distance area corresponding to the small image area of interest. The process then advances to step S812. In step S812, the area of interest is shifted to an adjacent small image area. The process then returns to step S803.

If the camera control unit or CPU determines in step S809 that n≠p, the process advances to step S810. In step S810, 1 is added to n, and the process returns to step S806.

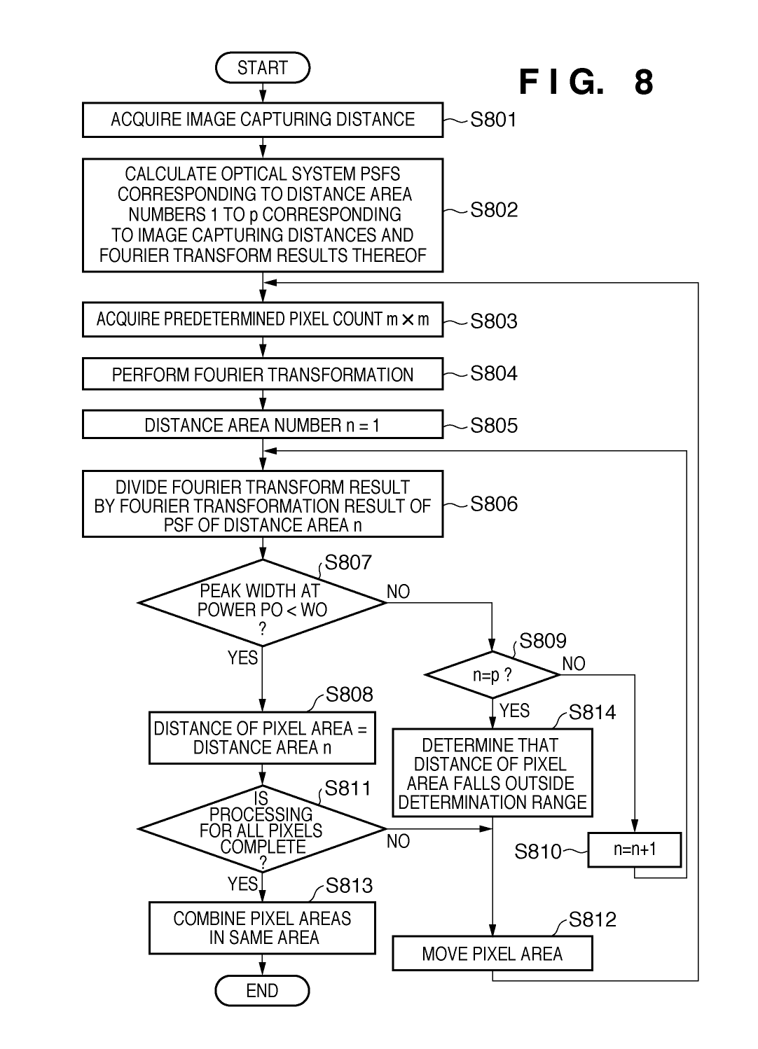

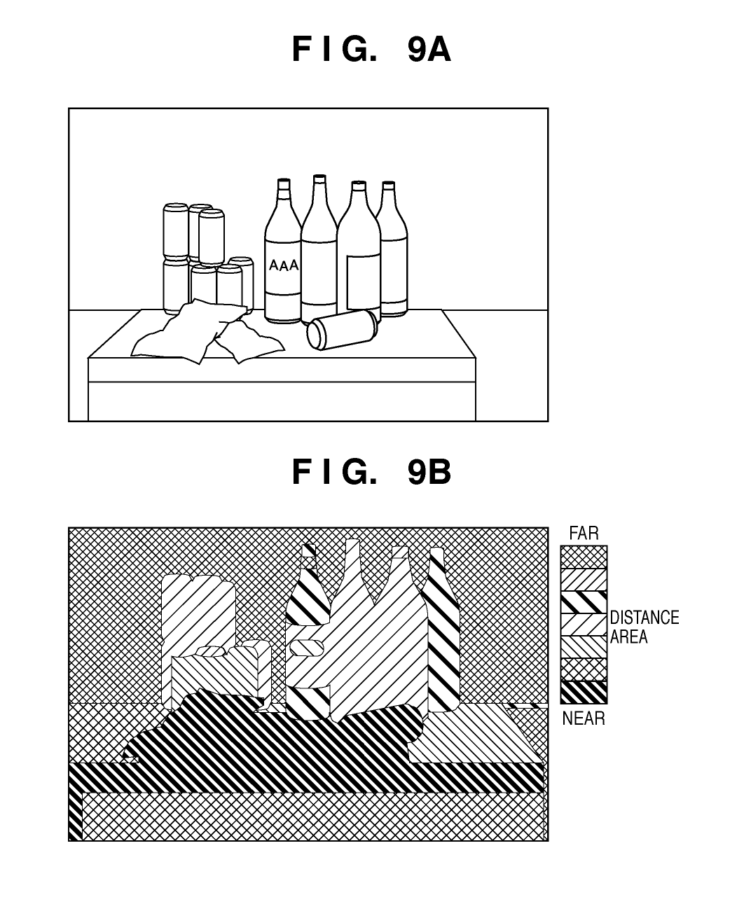

After the processing in step S808, the camera control unit or CPU determines in step S811 whether processing for all the pixels is complete. If the camera control unit or CPU determines that the processing is not complete, the process advances to step S812. If the camera control unit or CPU determines that the processing is complete, the process advances to step S813. In step S813, the camera control unit or CPU completes a distance image by combining the areas. FIGS. 9A and 9B are views respectively showing an image subjected to the processing following the flowchart of FIG. 8 and a processed image (distance image). FIG. 9A shows an image before the processing. FIG. 9B shows a distance image.

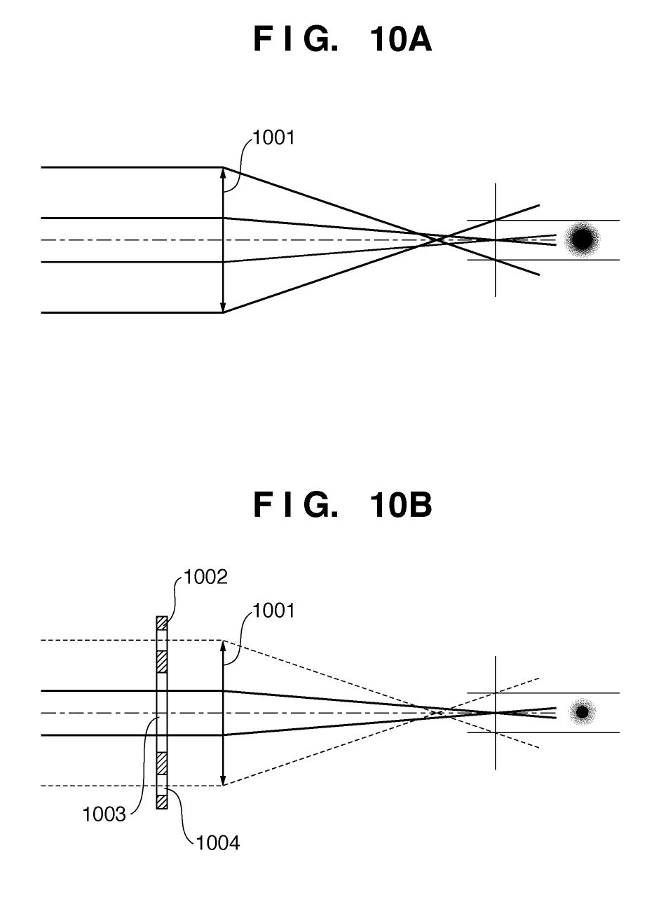

Another example of the use of a captured image file will be described next. FIGS. 10A and 10B are views for explaining the principle of a soft focus lens using spherical aberration. Reference numeral 1001 denotes a lens group having positive power. As shown in FIG. 10A, this lens group has large spherical aberration and obtains a soft focus effect by making a light beam passing through the periphery of the lens form a flare on the periphery of a light beam passing through the center of the lens. At this time, as shown in FIG. 10B, an aperture 1002 which limits the amount of light beam passing through the periphery limits the light beam from the periphery, thereby controlling the soft focus effect. Reference numeral 1003 denotes a main aperture on the optical axis; and 1004, a peripheral aperture which controls peripheral light.

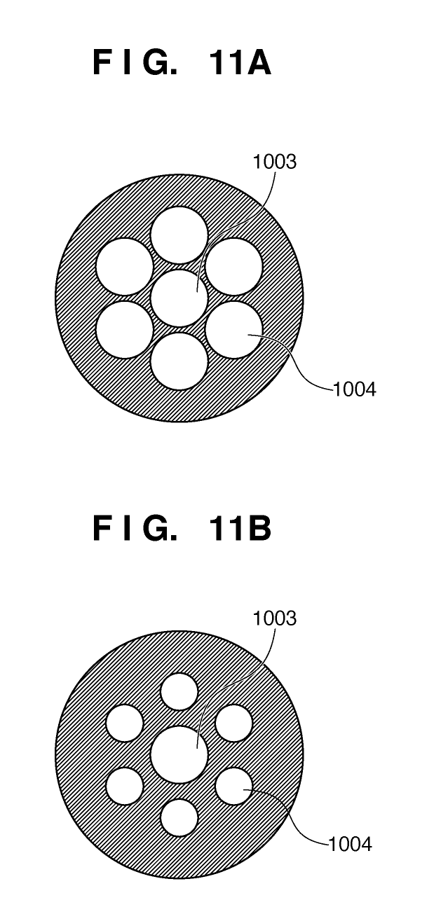

FIGS. 11A and 11B are views showing two types of aperture plates having different control effects. Each of the aperture plates has a main aperture 1003 and peripheral apertures 1004. The aperture plate driving mechanism 209 inserts or does not insert these aperture plates and switches them to obtain a desired soft focus effect. Using the aperture plate in FIG. 11A with a large-diameter peripheral apertures obtains a larger soft focus effect than when using the aperture in FIG. 11B with a small-diameter peripheral apertures. Using neither of the aperture plates will obtain a maximum soft focus effect.

Obviously, in this case, the pattern image of the aperture plate shown in FIG. 11A and the pattern image of the aperture plate shown in FIG. 11B are created in advance, and are stored in a memory (not shown) in the lens apparatus 200. Since the lens control unit 206 has information as to whether the currently used aperture plate is the one shown in FIG. 11A or 11B, it notifies the camera control unit 111 of a pattern image corresponding to the currently used aperture plate in the above manner.

In addition, when this type of aperture is used, a blur shape at an out-of-focus portion is similar to an opening shape of the aperture, and hence often exhibits dirty bokeh. The camera control unit 111 or software on a PC which processes image files in the camera can correct the bokeh shape by using aperture shape information. In this case, the camera control unit or software creates a PSF for a bokeh from the communicated aperture shape information, and creates a convolution filter for converting the PSF with actual bokeh into a PSF with ideal bokeh, thereby correcting the bokeh. Since this correction technique is a known technique, a detailed description of the technique will be omitted.

As has been described above, according to this embodiment, since the special aperture shape of a lens is transferred as an image to a camera or a PC which perform image processing, it is possible to perform display or processing based on the transferred aperture shape without losing the compatibility between different generation cameras, lenses, and processing software.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-134299 filed Jun. 3, 2009 which is hereby incorporated by reference herein in its entirety.

What is claimed is:

1. A lens apparatus configured to be detachable with respect to a lens-interchangeable image capturing device, and the lens apparatus includes an aperture plate having a plurality of openings, and includes a control mechanism which places the aperture plate at a specified position on an optical path and retracts the aperture plate from the specified position in accordance with external instructions, comprising:
a unit which holds a pattern of openings and non-openings of the aperture plate as a pattern image; and
a transmission unit which transmits the pattern image to the lens-interchangeable image capturing device when the control mechanism places the aperture plate at the specified position on the optical path in accordance with the external instruction.

2. The apparatus according to claim 1, wherein said transmission unit further transmits, to the lens-interchangeable image capturing device, size information indicating a size of an area on the aperture plate, which corresponds to one pixel of the pattern image.

3. The apparatus according to claim 1, wherein said transmission unit further transmits, to the lens-interchangeable image capturing device, a value of an F-number representing an aperture ratio which gives an amount of light transmitted through a lens, which is reduced by the aperture plate.

4. The apparatus according to claim 1, wherein the pattern image is a binary image obtained by assigning different bit values to the respective openings and non-openings.

5. The apparatus according to claim 1, wherein the pattern image is a multilevel image obtained by assigning pixel values corresponding to transmittances of light to the openings.

6. A control method for a lens apparatus configured to be detachable with respect to a lens-interchangeable image capturing device, and the lens apparatus includes an aperture plate having a plurality of openings, and includes a control mechanism which places the aperture plate at a specified position on an optical path and retracts the aperture plate from the specified position in accordance with external instructions, comprising:
transmitting a pattern of openings and non-openings of the aperture plate as a pattern image to the lens-interchangeable image capturing device when the control mechanism places the aperture plate at the specified position on the optical path in accordance with the external instruction.
